(19) United States
(12) Patent Application Publication
(10) Pub. No.: US 2013/0105477 A1
(43) Pub. Date: May 2, 2013

(54) SEALING SHEET FOR USE TO CLOSE A CONTAINER-DEFINING SHEET

(71) Applicant: Michel Bouthiette, Granby (CA)

(72) Inventor: Michel Bouthiette, Granby (CA)

(73) Assignee: 9155-0020 QUEBEC INC., Granby (CA)

(21) Appl. No.: 13/480,518

(22) Filed: May 25, 2012

(30) Foreign Application Priority Data
Oct. 28, 2011 (CA) 2756749

(51) Int. Cl. B65D 51/00; B23P 19/00

(52) U.S. Cl. 220/200; 29/700

(57) ABSTRACT

A sealing sheet for use to close a container-defining sheet having a top surface comprising a given number of spaced apart cavities embossed therein, each of the cavities being upwardly opened and thus defining a container that is surrounded by a flange that is part of the top surface of the container-defining sheet. The sealing sheet includes a top layer having a lower surface covered with a pressure sensitive adhesive glue, and a bottom layer having an upper surface detachably fixed to the lower surface of the top layer by means of the pressure sensitive adhesive glue, the bottom layer being peelable from the lower surface of the top layer to allow fixation of the sealing sheet onto the top surface of the container-defining sheet in order to close the container.

### CROSS-REFERENCE TO RELATED APPLICATION

The present invention claims the benefit of the priority of Canadian patent application n° 2,756,749 filed on Oct. 28, 2011.

### BACKGROUND OF THE INVENTION

The present invention relates to an improved sealing sheet for use to close a plurality of containers formed in a container-defining sheet, especially but not exclusively for the storage of pills.

The invention also relates to a set of pill containers which incorporates said improved sealing sheet.

### BRIEF DESCRIPTION OF THE PRIOR ART

It is of common practice in the pharmaceutical field to prepare sets of individual containers containing pills and/or tablets to be administered to a patient. Each of these containers contains pills and/or tablets that the patient has to take together at the same time during the day over a given period of time (preferably one week).

To prepare such sets of individual pill containers for use by a patient, it is also of common practice to use a sheet of plastic material in which a plurality of cavities are embossed. Each of these cavities defines a small upwardly opened container that can be filled with pills. After filling, all the containers are closed by means of a sealing sheet on which all desirable indications can be printed, like the patient's name, the date and hour of administration, etc. As it can be understood, the indications are printed and formatted onto the sealing sheet so that each group of information referring to a given container is positioned in regard to said container. Tearing lines are provided on both the container-defining sheet and the sealing sheet to permit easy separation of the individual pill containers.

For further information as to the structure, manufacture and use of such sets of individual pill containers, reference can be made to U.S. Pat. No. 5,788,079 and its Canadian counterpart no. 2,207,045 which both name the present inventor and are herein incorporated by reference, and to all the prior art references that were cited during their prosecution.

As disclosed in the above mentioned US and Canadian patents naming the present inventor, the sealing sheet used to close the containers can be made of paper or similar material and be glued onto the container-defining sheet. For this purpose, the sealing sheet comprises a top layer having a lower surface covered with a pressure sensitive adhesive glue and a bottom layer having an upper surface detachably fixed to the lower surface of the top layer by means of the adhesive glue. The bottom layer is peelable from the lower surface of the top layer to allow fixation of it onto the top surface of the container-defining sheet. Advantageously, this bottom layer has tearing lines punched into it in such a manner and position as to leave parts of it glued onto the bottom surface of the top layer in the form of a number of bottom pieces equal to the given number of cavities made in the container-defining sheet when the sealing sheet is peeled off. Each of these bottom pieces are shaped, sized and positioned so as to extend over a corresponding cavity of the container-defining sheet when the sealing sheet is properly applied to and glued on the flanges of the top surface of the container-defining sheet. These bottom pieces thus prevent the pill(s) stored in each of the containers from coming into contact with the adhesive glue.

As other examples of such a sealing sheet, reference can be made to U.S. Pat. Nos. 6,382,420 and 7,543,709 which also both name the present inventor and are also incorporated by reference.

The one disclosed in U.S. Pat. No. 7,543,709 is particularly interesting in that, thanks to its structure, it gives easy, safe and clean access to the containers formed in the container-defining sheet sealed by it.

However, a problem that still remains in the sealing sheets presently in use, especially the one of U.S. Pat. No. 7,543,709, is that the tearing lines of the bottom layer are positioned and devised so as to leave a pulling tab projecting from one edge of each bottom piece and an extension opposite to the edge from which extends the pulling tab, all of the tabs and extensions being in line and not separated from each other. So, it frequently happens that the bottom layer be teared off and splitted into parts when it is peeled off, such making it difficult to remove and glue the top layer onto the container-defining sheet.

### SUMMARY OF THE INVENTION

As aforesaid, the present invention as claimed is directed to an improved sealing sheet for use to close a container-defining sheet having a top surface comprising a given number of spaced apart cavities embossed therein, each of the cavities being upwardly opened and thus defining a container that is surrounded by a flange that is part of the top surface of the container-defining sheet.

Like the sealing sheet disclosed in U.S. Pat. No. 7,543,709, the sealing sheet according to the invention basically comprises:
a top layer having an upper surface and a lower surface, said lower surface being covered with a pressure sensitive adhesive glue; and
a bottom layer having an upper surface detachably fixed to the lower surface of the top layer by means of said pressure sensitive adhesive glue, said bottom layer being peelable from the lower surface of the top layer to allow fixation of the sealing sheet onto the top surface of the container-defining sheet in order to close the containers defined in the same.

The top layer has pairs of tearing lines punched therein. Each of said pairs of tearing lines is adjacent to one of the cover pieces extending from one side of said adjacent cover piece towards at least one adjacent corner of the bottom piece of the cover piece, in order to facilitate peeling of the bottom piece and of the corresponding part of the cover piece from the corresponding container and thus to give access to the element(s) stored in it.

The bottom layer also has tearing lines punched into it in such a manner and position as to leave parts of the bottom layer glued onto the bottom surface of the top layer in the form of a number of bottom pieces equal to the given number of cavities made in the container-defining sheet when said sealing sheet is peeled off. Each of said bottom pieces is shaped, sized and positioned so as to extend over a corresponding cavity of the container-defining sheet when the sealing sheet is properly applied to and glued on the flanges of the top surface of the container-defining sheet. Said bottom pieces thus prevent any element stored in the containers from coming into contact with the adhesive glue.

Advantageously, the container-defining sheet comprises recesses embossed therein so as to extend adjacent to the one side of each of the cover pieces from which extend the tearing lines allowing peeling of the corresponding bottom piece from the corresponding container. These recesses are U-shaped so as to give easy access to a finger and thus facilitate such a peeling.

Moreover, the tearing lines of the bottom layer of the sealing sheet are devised so as to provide each of the bottom pieces with a small pulling tab projecting from one edge of the bottom piece, in such a manner that once the sealing sheet is glued on top of the container defining-sheet, the pulling tab extending at a short a distance away from the cavity of the corresponding container towards the adjacent recess embossed therein, such facilitating again peeling of the bottom piece from the container. The tearing lines of the bottom layer of the sealing sheet are also devised so as to provide each of said bottom pieces with an extension opposite to the edge from which projects the pulling tab.

As aforesaid, the basic structure disclosed hereinabove of the sealing sheet according to the invention is known per se and disclosed in the above mentioned U.S. Pat. No. 7,543,709.

As a matter of fact, the sealing sheet according to the invention is improved in that the tearing lines of the bottom layer are further devised and positioned so that all of the pulling tabs and extensions that are formed when the bottom layer is peeled off, remain close to but separate from each other.

Such prevents the above mentioned problem encountered with the known sealing sheet, namely the fact that the bottom layer be often subject to be teared and splitted in parts when it is peeled off, because these is no part of said bottom layer left in between the holes formed by the bottom pieces, pulling tabs and extensions. In as much as, in accordance with the invention, the pulling tabs and extensions are close to but separate from each other, parts of the bottom layer remain between said tabs and expansions when said bottom layer is peeled off. Such substantially reduce the risk of tearing and splitting of the bottom layer, and thus make the installation of the top layer easier to achieve.

The present invention as claimed is also directed to kit for the manufacture of a set of pill containers, which comprises:

a) a container-defining sheet made of a plastic material, said container-defining sheet having a top surface comprising a given number of evenly spaced apart cavities embossed therein, each of said cavities being upwardly opened and thus defining a container, each of said containers being surrounded by a flange of a given width provided with a central dotted line punched therein, said dotted lines provided in all of said flanges making it possible to detach each of the containers from the container-defining sheet and from the adjacent containers;

b) a recessed support having a top surface provided with a number of recesses at least equal to the number of cavities embossed in the container-defining sheet, said recesses being positioned, shaped and sized to receive the containers defined by said cavities embossed in the container-defining sheet; and

c) a sealing sheet for use to close the container-defining sheet, said sealing sheet being as defined hereinabove.

Of course, positioning means are provided onto at least the top surface of the container-defining sheet and on the sealing sheet to ensure that, in use, after the container-defining sheet is fitted onto the recessed support, the paper covering is peeled off from the bands of the sealing sheet and said sealing sheet is positioned on top of the top surface of the container-defining sheet, the bands covered with a self-adhesive material and their tearing lines be in exact superposition on top of the flanges and the dotted lines of the container-defining sheet.

In accordance with a particularly preferred embodiment of the invention, the recessed support of the above mentioned kit, comprises a pair of holes located on opposite sides of its top surface close to the side where are located the upwardly projecting protuberances. Such is interesting in that the holes made in the recessed support allow the user to insert his/her fingers below the container-defining sheet and thus facilitate removal of the same.

This invention and its numerous advantages will be better understood upon reading the following non restrictive description of the closest prior art and of a preferred embodiment of the invention, made with reference to the accompanying drawings.

### BRIEF DESCRIPTION OF THE DRAWINGS

FIG. 1 identified as “prior art”, is an exploded perspective view of a recessed support, a container defining sheet, and the bottom and top layers of a sealing sheet of the set of individual peel container disclosed in U.S. Pat. No. 7,543,709;

FIG. 2 identified as “prior art”, is a perspective view showing how the bottom layer of the sealing sheet disclosed in U.S. Pat. No. 7,543,709 may be peeled off while leaving the bottom pieces attached to the bottom surface of the top layer of the sealing sheet to close each of the containers;

FIG. 3 is a perspective view similar to the one shown in FIG. 2 but illustrating the structure of the bottom and top layer of the sealing sheet according to the preferred embodiment of the invention;

FIG. 4 is a bottom plan view of the sealing sheet illustrated in FIG. 3; and

FIG. 5 is a perspective view of a recessed support similar to the one shown in FIG. 1, but with holes on both of its sides to facilitate removal of the containing-defining sheets inserted in it or stacked onto each other into it.

### DESCRIPTION OF THE CLOSEST PRIOR ART AND OF A PREFERRED EMBODIMENT OF THE INVENTION

As indicated hereinabove, the present invention relates to an improvement made to the structure of a sealing sheet for use to seal a container-defining sheet like those especially devised to form sets of individual pill containers for use in pharmacies or hospitals.

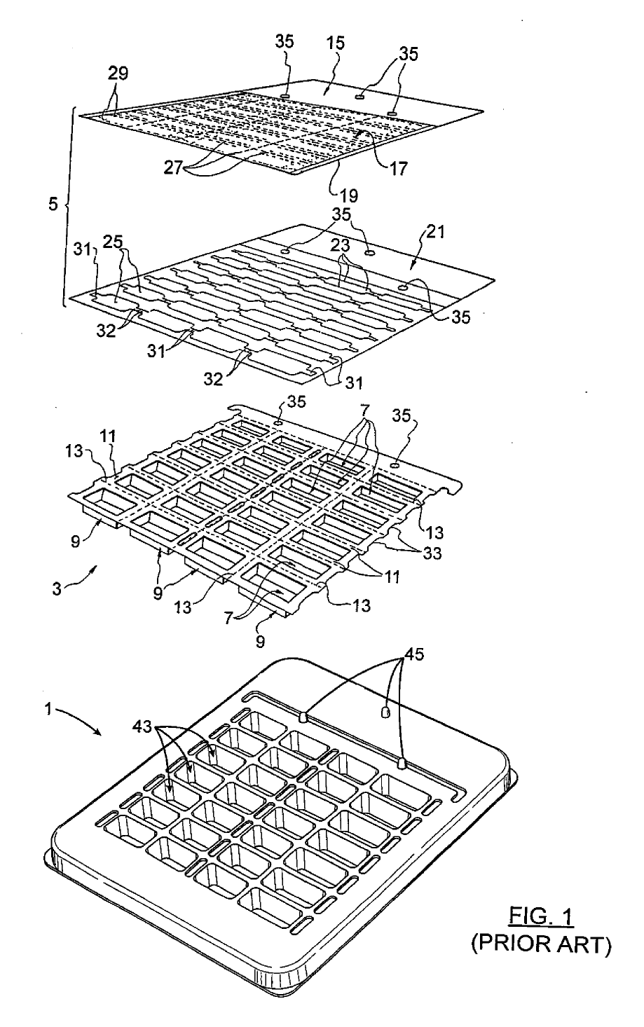

A aforesaid, FIG. 1, identified as “prior art” illustrate a kit comprising a recessed support 1, a container-defining sheet 3 and a sealing sheet 5 intended to be attached on top of the container-defining sheet 3, as disclosed in U.S. Pat. No. 7,543,709.

The container-defining sheet 3 is preferably made of a plastic material and has a top surface comprising a given number of spaced apart cavities 7 embossed therein. Each cavity 7 is upwardly opened and thus defines a container 9 which is surrounded by a flange 11. Each of the flanges 11 which is not directly adjacent to one external side of the container-defining sheet 3 is provided with a centrally positioned tearing line 13 so as to make it possible to detach each of the containers 9 from all the adjacent containers and thus from the container-defining sheet 3 whenever desired.

The sealing sheet 5 is preferably made of paper and devised to be positioned on top of the top surface of the container-defining sheet 3 in order to close each of the containers.

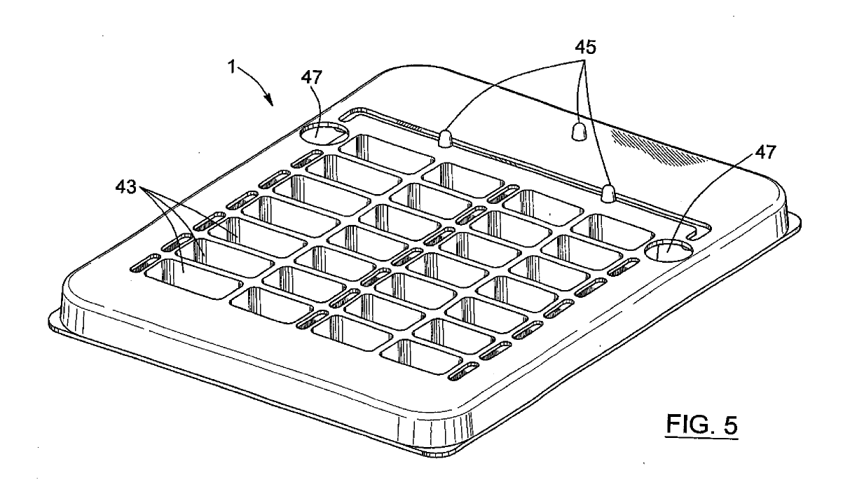

As it is illustrated, the sealing sheet 5 comprises a top layer 15 which has an upper surface 17 and a lower surface 19 that is covered with a pressure-sensitive adhesive glue. The sealing sheet 5 also comprises a bottom layer 21 that is detachably fixed to the lower surface 19 of the top layer 15 by means of the adhesive glue. The bottom layer 21 is devised to be peelable from the lower surface 19 of the top layer 15 in order to allow fixation of the sealing sheet 5 on to the top surface of the container-defining sheet 3 in order to close all the containers 9 made in this sheet 3. The way the bottom layer 21 may be peeled oft from the lower surface 19 of the top layer 15 is illustrated in FIG. 5.

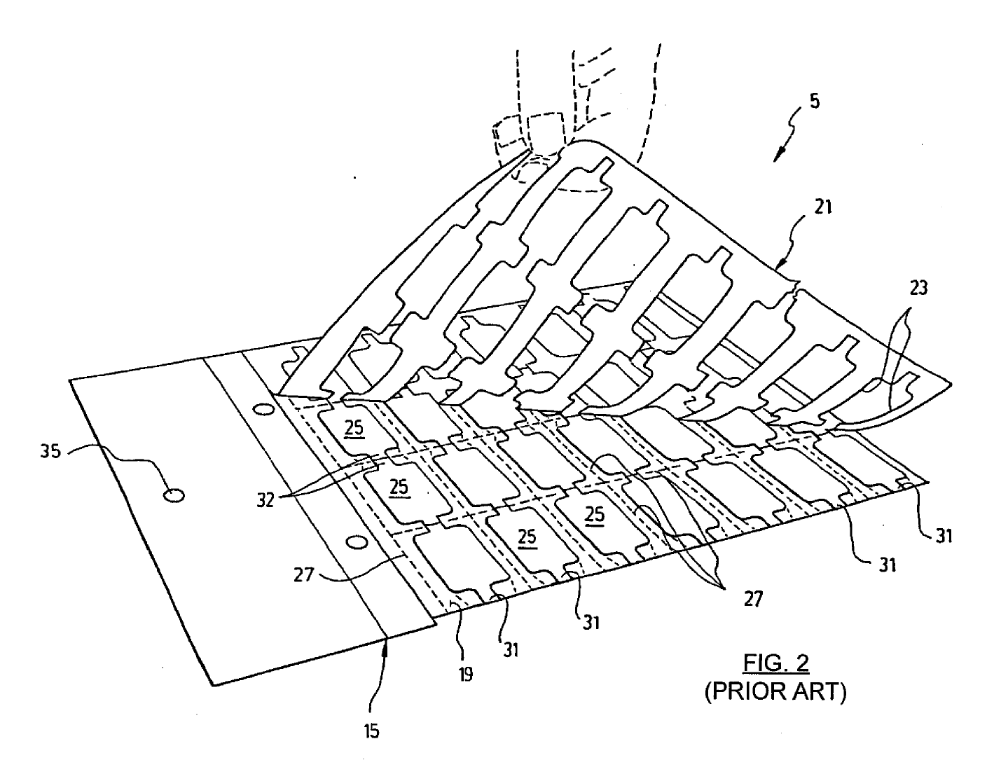

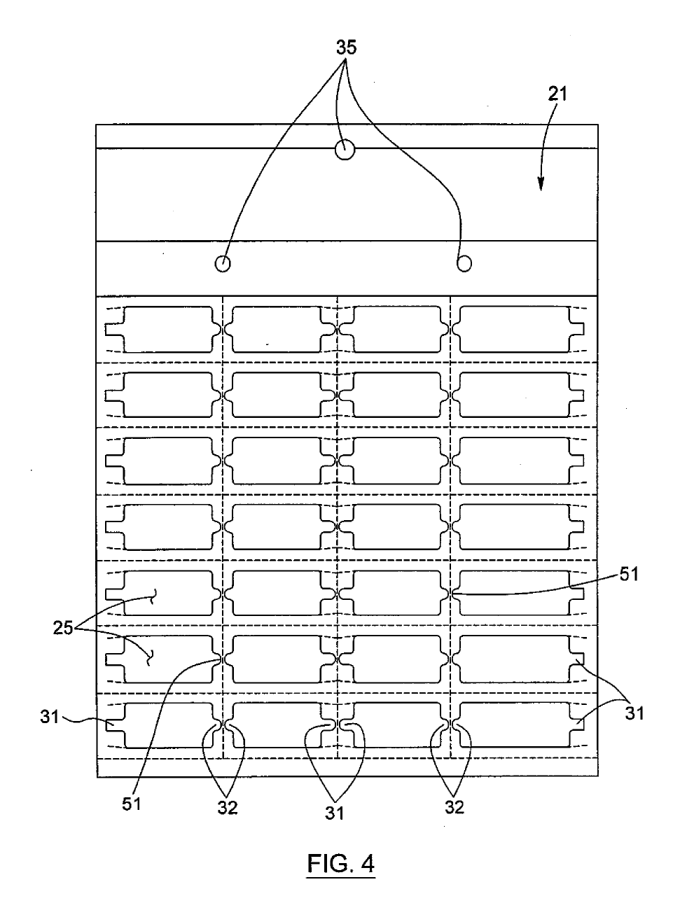

As it is shown in FIG. 1 as well as in FIG. 2 also identified as “prior art”, the bottom layer 21 of the sealing sheet has tearing lines 23 that are punched into it in such a manner and position as to leave parts of the bottom layer 21 glued onto the bottom surface 19 of the top layer 15 in the form of a number of bottom pieces 25 equal to the number of cavities 7 made in the container-defining sheet 3 when the sealing sheet 5 is peeled off. Each of the bottom pieces 25 is shaped, sized and positioned so as to extend over a corresponding cavity 7 of the container-defining sheet 3 when the sealing sheet is properly applied to and glued on the flanges 11 located on the top surface of the container-defining sheet 3. As a result, these bottom pieces 25 prevent any element like pills stored in the containers 9, from coming into contact with the adhesive glue that was originally applied to all the adjacent surfaces of the top and bottom layers 15 and 21 of the sealing sheet 5. As to the particular position and protective effect of each of the bottom pieces 25, reference can be made to FIGS. 2 and 4 of the drawings.

Of course, when the container-defining sheet 3 is devised so as to allow each of its containers to be detached as was disclosed above and is illustrated in the drawings, the top layer 15 of the sealing sheet 5 must have tearing lines 27 punched therein in such a manner and position as to be in line with the tearing lines 13 of the container-defining sheet 3, in order to allow the top layer 15, once glued onto the flanges 11 on top of the container-defining sheet 3, to be splitted into a number of cover pieces 17 equal to the number of containers 9. Such is actually necessary to allow detachment of each of the containers 9 from the container-defining sheet 3 while keeping the so-detached containers closed.

As it is illustrated, the top layer 15 of the sealing sheet 5 has pairs of tearing lines 29 punched therein, each of said pairs being adjacent to one of the cover pieces 17 and having each of its tearing lines 29 that extends from one side of the corresponding cover piece 17 towards one adjacent corner of the corresponding bottom piece 25.

The purpose of these tearing lines 29 is to facilitate peeling of the bottom piece 25 and of the corresponding part of the cover piece 17 from the corresponding container and thus facilitate access to the elements stored therein.

As it is also illustrated, the bottom layer 21 of the sealing sheet 5 also has the tearing lines 23 which are devised to provide each of the bottom pieces 25 with a small pulling tab 31 projecting from one edge 26 of the bottom piece, hereinafter called “front edge”, in such a manner that, once the sealing sheet 5 is glued on top of the container-defining sheet 3, this pulling tab 31 extends at a short distance away from the cavity 7 of the corresponding container 9 towards an adjacent recess 33 embossed therein. Such again advantageously facilitates peeling of the bottom piece 25 from the container 9.

As is shown in FIG. 1, the recesses 33 are preferably U-shaped, so as to give easy access to a finger and thus facilitate such a peeling. Such substantially facilitates access to the content of each container 9, as compared to what was done so far.

As is further illustrated in FIGS. 1 and 2, the tearing lines 23 of the bottom layer 21 of the sealing sheet 5 are devised so as to provide each of the bottom pieces 25 with an extension 32 that is opposite to the front edge 26 from which projects the pulling tab 31.

Such an extension 32 which extends over over a portion of the rear edge of the bottom piece 25, advantageously allows the rear end of the bottom piece 25 to remain attached onto the adjacent surface of the corresponding container 9 and thus to prevent inadvertent separation of the rear portion of the bottom piece 25 from the top layer 15 on which said bottom piece is glued, with the risk of inadvertent gluing of the pills stored in the container.

As it has already been mentioned hereinabove, a problem that exists with the sealing sheets presently in use, especially the one of U.S. Pat. No. 7,543,709 illustrated in FIGS. 1 and 2, is that the tearing lines of the bottom layer 21 are positioned and devised so as to leave a pulling tab 31 projecting from one edge of each bottom piece 25 and an extension 32 opposite to the edge from which extends the pulling tab 31, all of the tabs 31 and extensions 32 being in line and not separated from each other as is clearly illustrated in FIG. 2. So, it frequently happens that the bottom layer 21 be teared off and spitted into parts when it is peeled off, as it is also illustrated in FIG. 2, such making difficult to remove and glue the top layer 15 onto the container-defining sheet.

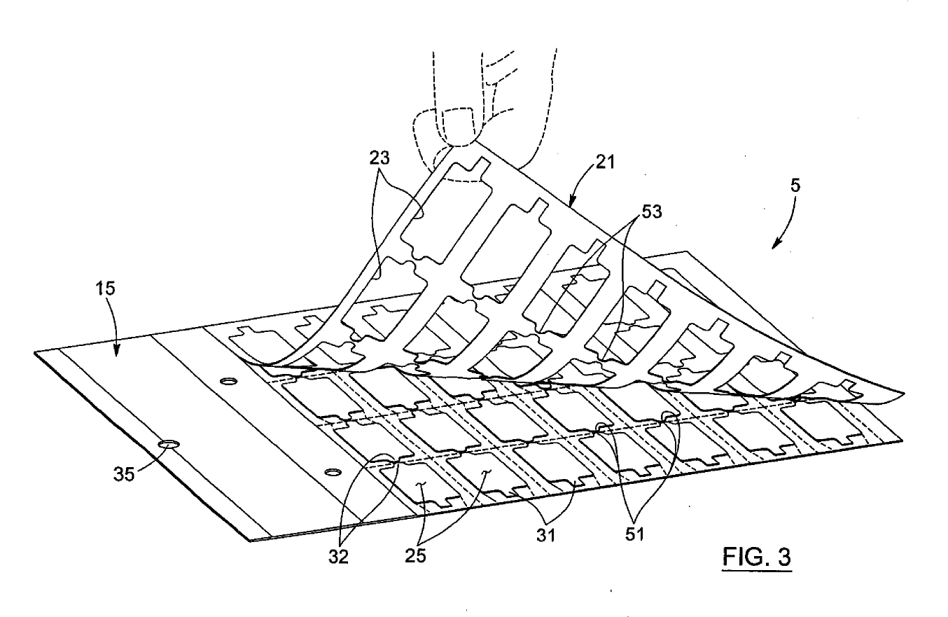

To prevent the above problem, the sealing sheet 21 according to the invention as shown in FIGS. 3 and 4, is improved in that the tearing lines of the bottom layer 21 are devised and positioned so that all the pulling tabs 31 and extensions 32 that are formed in the top layer 15 when the bottom layer 21 is peeled off, remain close to but separate from each other over a small length 51.

As aforesaid, such prevents the above mentioned problem encountered with the known sealing sheet, namely the fact that the bottom layer be often subject to be teared and splitted in parts when it is peeled off, because these is no part of the bottom layer left in between the holes formed by the bottom pieces, pulling tabs and extensions. In as much as, in accordance with the invention, the pulling tabs 31 and extensions 32 are close to but separate from each other, the bottom layer has parts that remain in the spaces left between said tabs and expansions when said bottom layer peeled off. Such substantially reduce the risk of tearing and splitting of the bottom layer, and thus make the installation of the top layer easier to achieve.

In the prior art embodiment disclosed hereinabove as well as in the preferred embodiment according to the invention as illustrated in FIGS. 3 and 4 of the accompanying drawings, the sets for individual pill containers are intended to be used in the pharmaceutical field. So, the container-defining sheet 3 preferably comprises twenty-eight containers that are positioned in order to define seven rows and four columns. The sealing 5 is devised to form a corresponding number of cover pieces 17 each of which can be printed with relevant information as to the content of the corresponding container, and the date and hour the pills contained therein must be taken.

Such a particular use is of course of interest when pills and/or tablets must be administered every day at different periods of time. As to the way the above mentioned printing can be done and its advantage, reference can be made afore to U.S. Pat. No. 5,788,079 naming the present inventor, which has already been mentioned hereinabove.

Of course, it may be understood that, for other applications, the kind of printing and the number of containers may vary.

As also shown in the accompanying drawings, the sealing sheet 5 and the top surface of the container-defining sheet 3 are advantageously provided with positioning means such as holes 35 that may cooperate with pins 45 extending from the recessed support 1 in order to ensure proper positioning of both of them with respect to each other during installation and exact superimposition of the bottom pieces 25 of the sealing sheet on top of the corresponding cavities 7 and with all the tearing lines of the top layer of the sealing sheet in alignment with the tearing lines of the container-defining sheet 3.

The purpose of the recessed support 1 which is preferably made of rigid plastic material, is actually to receive, hold and support one or more of said container-defining sheet 3. For this purpose, it comprises on its top surface, a plurality of recesses 43 that are equal in number to the number of containers 9 embossed on the container-defining sheet 3, and are positioned, shaped and sized to receive these containers 9.

As to the way the assembly can be achieved, reference can again be made to the above mentioned U.S. Pat. No. 5,788,079.

As is shown in FIG. 5, the recessed support 1 used in accordance with the present invention differs from the one used so far and illustrated in FIG. 1, in that it comprises a pair of holes 47 located on opposite sides of its top surface close to the side where are located the upwardly projecting protuberances 45. Such is particularly interesting in that the holes 47 made in the recessed support allow the user to insert his/her fingers below the container-defining sheet and thus facilitate removal of the same.

As may be appreciated, numerous modifications could be made to the preferred embodiment of the sealing sheet according to the invention and of the kit in which it can be used as it disclosed hereinabove without departing from the scope of the present invention. In this connection, it is worth reminding that the present invention, even though it is particularly well adapted to the manufacture of sets of individual pill containers for use in the pharmaceutical field, it could be used in other fields for other applications. It may also be noted that the number of containers may vary from one application to another and the shape and size of each of the containers may be modified as requested.

What is claimed is:

1. A sealing sheet for use to close a container-defining sheet having a top surface comprising a given number of spaced apart cavities embossed therein, each of said cavities being upwardly opened and thus defining a container that is surrounded by a flange that is part of the top surface of said container-defining sheet, said sealing sheet comprising:
a top layer having an upper surface and a lower surface, said lower surface being covered with a pressure sensitive adhesive glue; and
a bottom layer having an upper surface detachably fixed to the lower surface of the top layer by means of said adhesive glue, said bottom layer being peelable from the lower surface of the top layer to allow fixation of the sealing sheet onto the top surface of the container-defining sheet in order to close the containers defined in the same;
said top layer having pairs of tearing lines punched therein, each of said pairs of tearing lines being adjacent to one of said cover pieces extending from one side of said adjacent cover piece towards at least one adjacent corner of the bottom piece of said cover piece, in order to facilitate peeling of said bottom piece and of the corresponding part of the cover piece from the corresponding container and thus to give access to the element(s) stored in it;
said bottom layer also having tearing lines punched into it in such a manner and position as to leave parts of said bottom layer glued onto the bottom surface of the top layer in the form of a number of bottom pieces equal to the given number of cavities made in the container-defining sheet when said sealing sheet is peeled off, each of said bottom pieces being shaped, sized and positioned so as to extend over a corresponding cavity of the container-defining sheet when the sealing sheet is properly applied to and glued on the flanges of the top surface of the container-defining sheet, said bottom pieces thus preventing any element stored in the containers from coming into contact with the adhesive glue,
wherein the container-defining sheet comprises recesses embossed therein so as to extend adjacent to the one side of each of the cover pieces from which extend the tearing lines allowing peeling of the corresponding bottom piece from the corresponding container, said recesses being U-shaped so as to give easy access to a finger and thus facilitate such a peeling; and
wherein the tearing lines of the bottom layer of the sealing sheet are devised so as to provide each of the bottom pieces with a small pulling tab projecting from one edge of the bottom piece, in such a manner that once the sealing sheet is glued on top of the container defining-sheet, said pulling tab extending at a short a distance away from the cavity of the corresponding container towards the adjacent recess embossed therein, such facilitating again peeling of said bottom piece from said container, the tearing lines of the bottom layer of said sealing sheet being also devised so as to provide each of said bottom pieces with an extension opposite to the edge from which projects the pulling tab,
said sealing sheet that being characterized its that the tearing lines of the bottom layer are further devised and positioned so that all of the pulling tabs and extensions that are formed when the bottom layer is peeled off, remain close to but separate from each other, such reinforcing the structure of the bottom layer and preventing it from being teared or splitted in parts when it is peeled off.

2. The sealing sheet of claim 1, wherein:
each of the flanges that are parts of the top surface of the container-defining sheet and are not directly adjacent to one side of said container-defining sheet, are provided with a centrally positioned tearing line so as to make it possible to separate each of the containers from the adjacent containers and thus from the container-defining sheet whenever desired; and
the top layer of the sealing sheet also have other tearing lines punched therein in such a manner and position as to be in line with the tearing lines of the container-defining sheet and thus to allow said top layer, once glued onto the flanges of the container-defining sheet, to be splitted into a number of cover pieces equal to the number of containers, such making it possible to detach each of said containers from the container defining sheet while keeping it closed.

3. The sealing sheet of claim 2, wherein the top layer has additional tearing lines punched therein in such a manner as to extend so toward the pulling tab along the edge of the bottom piece from where said pulling tab projects, said additional tearing lines extending transversally from the corners of the bottom piece along the edge of it, up to the pulling tab.

4. The sealing sheet of claim 4, wherein:
the containers defined by the cavities of the container-defining sheet are positioned to form rows and columns; and
the cover pieces splittable from the sealing sheet are similarly positioned so as to correspond to said rows and columns.

5. The sealing sheet of claim 4, wherein the sealing sheet and the top surface of the container-defining sheet are provided with positioning means to ensure proper positioning of both of them with respect to each other during installation and thus exact superimposition of the bottom pieces of the sealing sheet on top of the corresponding cavities, and exact superimposition of the tearing lines of the top layer of the sealing sheet with the tearing lines of container-defining sheet.

6. The sealing sheet of claim 5, wherein said positioning means consists of at least two spaced apart holes sized to fit onto pins projecting from a support.

7. The sealing sheet of claim 6, wherein the top surface of said sealing sheet comprises information printed on it in such a manner as to be positioned on top of each cover piece and thus to correspond to what is located in the corresponding container.

8. The sealing sheet of claim 7, wherein:
said sealing sheet is made of paper; and
said container defining sheet is made of plastic material.

9. The sealing sheet of claim 8, wherein the upper surface of the bottom layer of the sealing sheet is covered with silicone.

10. The sealing sheet of claim 9, wherein:
the container-defining sheet is intended to store individual pills and comprises twenty-eight containers, said containers being positioned to define seven rows and four columns; and
the sealing sheet is devised to form a corresponding number of cover pieces that are each printed with relevant information as to the content of the corresponding containers and the date and hour the pills contained therein must be taken.

11. A kit for the manufacture of a set of pill containers, said kit comprising:
a) a container-defining sheet made of a plastic material, said container-defining sheet having a top surface comprising a given number of evenly spaced apart cavities embossed therein, each of said cavities being upwardly opened and thus defining a container, each of said containers being surrounded by a flange of a given width provided with a central dotted line punched therein, said dotted lines provided in all of said flanges making it possible to detach each of the containers from the container-defining sheet and from the adjacent containers;
b) a recessed support having a top surface provided with a number of recesses at least equal to the number of cavities embossed in the container-defining sheet, said recesses being positioned, shaped and sized to receive the containers defined by said cavities embossed in the container-defining sheet;
c) a sealing sheet for use to close the container-defining sheet, said sealing sheet being as defined in claim 1; and
d) positioning means provided onto at least the top surface of the container-defining sheet and on the sealing sheet to ensure that, in use, after the container-defining sheet is fitted onto the recessed support, the paper covering is peeled off from the bands of the sealing sheet and said sealing sheet is positioned on top of the top surface of the container-defining sheet, the bands covered with a self-adhesive material and their tearing lines be in exact superposition on top of the flanges and the dotted lines of the container-defining sheet.

12. A kit according to claim 11, wherein said positioning means comprises:
three (3) upwardly projecting protuberances provided on one side of the top surface of the recessed support,
two (2) holes provided into the container-defining sheet; and
three (3) holes provided in the sealing sheet,
all of said holes being sized and positioned so as to allow proper positioning of the said container-defining sheet and said sealing sheet onto the recessed support by proper engagement in said protuberances.

13. A kit according to claim 12, wherein the recessed support comprises a pair of holes located on opposite sides of its top surface close to the side where are located the upwardly projecting protuberances, so as to allow insertion of fingers below the container-defining sheet in order to facilitate removal of the same.
